(19) United States
(12) Patent Application Publication
(10) Pub. No.: US 2022/0037878 A1
(43) Pub. Date: Feb. 3, 2022

(54) PROVISIONAL OVERVOLTAGE PROTECTION FOR A LUMINAIRE

(71) Applicant: SIGNIFY HOLDING B.V., EINDHOVEN (NL)

(72) Inventors: Matthias WENDT, WüRSELEN (DE); Harald Josef Günther RADERMACHER, AACHEN (DE); Bozena ERDMANN, AACHEN (DE)

(21) Appl. No.: 17/299,560

(22) PCT Filed: Dec. 6, 2019
(86) PCT No.: PCT/EP2019/084033

§ 371 Date: Jun. 3, 2021

(30) Foreign Application Priority Data
Dec. 14, 2018 (EP) 18212581.5

(51) Int. Cl. H02H 9/04; H05B 47/20

(52) U.S. Cl. CPC H02H 9/043; H05B 47/20

(57) ABSTRACT

The invention is related to a luminaire comprising a lighting module for emitting light, a driver for driving operation of the lighting module, a runtime overvoltage protection device for protecting the lighting module and the driver from exposure to overvoltage above a first overvoltage tripping limit, and a provisional overvoltage protection device that is connected in parallel to the runtime overvoltage protection device and has a second overvoltage tripping limit. The second tripping limit smaller than the first overvoltage tripping limit so that the provisional overvoltage protection device provides overvoltage protection to the runtime overvoltage protection device. Moreover, the provisional overvoltage protection device is deactivatable.

### FIELD OF THE INVENTION

The present invention is directed to a luminaire and to a luminaire kit comprising a luminaire unit and a plug-in overvoltage protection unit.

### BACKGROUND OF THE INVENTION

An overvoltage protection device, also referred to as surge protection device, serves to protect electrical devices from overvoltage events. In the case of an overvoltage event such as a transient voltage surge, in contrast to a fuse or a circuit breaker, an overvoltage protection device dissipates or absorbs the voltage surge.

US 2017/0245341 A1 discloses an LED driving device that includes a converter module configured to receive an input voltage and generate an output voltage for driving a lighting device in the form of a plurality of LEDs. A runtime overvoltage protection device formed by a surge protection module is electrically connected to the converter module. A case holds the converter module and the runtime overvoltage protection device and provides electrical coupling there between.

### SUMMARY OF THE INVENTION

It would be beneficial to improve overvoltage protection of a luminaire.

According to a first aspect of the present invention, a luminaire is provided that comprises a lighting module for emitting light, a driver for driving operation of the lighting module, a runtime overvoltage protection device for protecting the lighting module and the driver from exposure to overvoltage above a first overvoltage tripping limit. Moreover, the luminaire comprises a provisional overvoltage protection device that is connected in parallel to the runtime overvoltage protection device and has a second overvoltage tripping limit. The second overvoltage tripping limit is smaller than the first overvoltage tripping limit so as to provide overvoltage protection to the runtime overvoltage protection device. Furthermore, the provisional overvoltage protection device is deactivatable.

The invention is based on the recognition that under certain temporary exceptional operational circumstances mains power provision to a luminaire can be unstable and subject to a risk of frequent overvoltage events. An example of such a temporary operational circumstance is a construction phase in a building with pre-installed luminaires. Here, the usage of high-power machinery attached to electrical circuits also used for providing power to the luminaire can cause frequent overvoltage events, in particular if these electrical circuits do not fully support high power requirements of the machinery used. Other exemplary exceptional operational circumstances that can lead to overvoltage events are installation work on live voltage or with energized circuits. This may for instance be the case in three-phase systems, under swapping of phase and neutral, or under a floating neutral. In such situations, e.g., a voltage amount of 400V can be delivered for certain time spans instead of 230V. A runtime overvoltage protection device directly exposed to such overvoltage events in those exceptional operational circumstances may suffer damage and degrade. As a result, the runtime overvoltage protection device may provide only limited overvoltage protection during normal operational circumstances of the luminaire, and the lifetime of the luminaire may be considerably shortened.

In contrast, the luminaire of the present invention is more resistant to overvoltage events due to the additional provision of the provisional overvoltage protection device. Since the second overvoltage tripping limit of the provisional overvoltage protection device is smaller than the first overvoltage tripping limit of the runtime overvoltage protection device, only the provisional overvoltage protection device suffers from degradation during overvoltage events. In other words, the provisional overvoltage protection device is configured to avoid exposure of the runtime overvoltage protection device to overvoltages higher than the second overvoltage tripping limit. The runtime overvoltage protection device thus does not suffer damage from such overvoltage events during exceptional operational circumstances.

Since the provisional overvoltage device is deactivatable, the additional overvoltage protection provided by the provisional overvoltage device is also deactivatable, thus allowing to operate the luminaire under overvoltage protection of only the runtime overvoltage protection device after the deactivation. This is particularly useful when exceptional overvoltage circumstances are terminated and the luminaire is back to operation under normal operational circumstances.

In the following, embodiments of the luminaire of the first aspect of the present invention will be described.

In different embodiments of the luminaire of the first aspect, the provisional overvoltage protection device is provided on a support carrying a conductor trace for establishing a parallel electrical connection between the runtime overvoltage protection device and the provisional overvoltage protection device. A mechanism for allowing deactivation of the provisional overvoltage protection device in these embodiments can be made in different ways, as explained in the following.

In one alternative embodiment, a socket is connected to the conductor trace, in parallel to the runtime overvoltage protection device, and an electrical contact bridge is removably plugged into the socket and comprises the provisional overvoltage protection device, such that removing the electrical contact bridge opens the electrical connection between the runtime overvoltage protection device and the provisional overvoltage protection device and thus deactivates the provisional overvoltage protection device. This embodiment allows a re-use of the provisional overvoltage protection device after removal from the socket, be it in the same luminaire or in another luminaire. The handling of the provisional overvoltage protection device is improved in variants of this embodiment, in which the provisional overvoltage protection device comprises a grip such that by pulling on the grip, the provisional overvoltage protection device is removed from the luminaire. In another variant, the grip furthermore comprises a visually obtrusive symbol such as an arrow extending from a body of the luminaire to indicate that the provisional overvoltage protection device is still in place.

In a second alternative embodiment, the conductor trace comprises solder joints electrically connected by an electrical contact bridge such that the electrical contact bridge and the provisional overvoltage protection device are connected in a series connection. The electrical contact bridge is arranged on a foil which is removably attached to the support such that by removing the foil, the electrical contact bridge is removed as well. As a result, an electrical connection between the runtime overvoltage protection and the provisional overvoltage protection becomes disrupted thereby deactivating the provisional overvoltage protection device. The removal of the contact bridge through a removable foil provides a low-cost solution for the deactivation mechanism of the provisional overvoltage protection device.

In a different variant, the electrical contact bridge includes the provisional overvoltage protection device.

In another variant, the foil carrying the electrical contact bridge is realized by a conductor trace on a printed flex-foil, which is soldered to the support. In yet another variant, the foil includes predetermined breaking points such that by pulling on the foil, a part of the electrical contact bridge and the foil are removed, while another part of the electrical contact bridge and the foil remains on the support. In yet a different variant, the luminaire also comprises a housing, and the foil carrying the electrical contact bridge also covers part of the housing or the lighting module as a means of protection, e.g., against dust, paint, or damage. In another variant, this foil protecting the housing or lighting module is translucent to allow light emitted from the luminaire to pass. In yet another variant the foil is translucent and dyed as a reminder to the user or operator of its intended removal before use of the luminaire under normal operational circumstances.

In a further variant, the luminaire additionally comprises a maintenance interface, e.g., a maintenance port for manual maintenance, an electrical port for programming or commissioning purposes, or the like. The foil carrying the contact bridge also covers at least parts of the maintenance interface. Thus, in the course of accessing the interface, the foil has to be removed, and thereby the provisional overvoltage protection device is deactivated. In an alternative making use of a socket connected to the conductor trace as described above in the context of another embodiment, the provisional overvoltage protection device is arranged such that a person seeking access to the maintenance port synchronously removes the provisional overvoltage protection device from its socket.

In a third alternative forming an embodiment of the luminaire of the first aspect, the conductor trace comprises a conductive electrical contact bridge that, by receiving an optical or electrical deactivation pulse, is removable or transformable to a non-conductive trace section, thus disrupting the electrical connection between the runtime overvoltage protection device and the provisional overvoltage protection device and thus deactivating the provisional overvoltage protection device. Furthermore, the luminaire comprises a deactivation unit that is configured to generate and provide the electrical or optical deactivation pulse and a control unit that is connected to the deactivation unit and is configured to trigger the deactivation unit to provide the deactivation pulse to the contact bridge.

In this alternative, the deactivation of the provisional overvoltage protection device can be accomplished by removing or transforming the conductive electrical contact bridge using optical or electrical means, such as a pulse having a suitable amount of energy or power, depending on the material of the conductive electrical contact bridge. Different approaches are used to implement the removal or transformation of the conductive electrical contact bridge in this third alternative.

In one approach, the conductive electrical contact bridge comprises a onetime fusible trace. The deactivation pulse is an electrical current generated by the deactivation unit, which burns the onetime fusible trace when the deactivation unit is triggered by the control unit. In a variant, the onetime fusible trace is socketed and as such allows a reactivation of the provisional overvoltage protection device by replacing the burnt onetime fusible trace. The reactivation is of advantage when the exceptional operational circumstances reoccur.

In a different approach, the deactivation unit is a light source and the conductive electrical contact bridge is realized by a photosensitive material that degrades when hit by light emitted from the deactivation unit. In yet another approach, the conductive electrical contact bridge is realized by a photosensitive material that degrades when light emitted by the lighting module hits the contact bridge. In this variant, the lighting module is operated in a low intensity mode corresponding to a low light flux level. The deactivation unit is configured to change the operation of the lighting module to a high intensity mode corresponding to a high light flux level when triggered by the control unit. While the conductive electrical contact bridge is unaffected by the low light flux level, the high light flux level is sufficiently strong to degrade the conductive electrical contact bridge and as a result deactivate the provisional overvoltage protection device.

In yet another approach, the luminaire additionally comprises an operation-time counter unit that is connected in series with the driver and is configured to calculate an accumulated operation time of the luminaire by measuring the time periods that a current is passing through the connection to the driver. Furthermore, the operation-time counter unit provides a signal indicative of the accumulated operation time to the control unit. The control unit is configured to compare the accumulated operation time to a predetermined threshold and to trigger the deactivation unit when the accumulated operation time exceeds the threshold. This functionality is in another embodiment implemented by using a trace material that degrades after a predetermined amount of time.

In another variant, the luminaire additionally comprises a communication interface that is configured to receive a deactivation trigger signal from an external signal source and that is configured to forward the deactivation trigger signal to the control unit. Moreover, the control unit is configured to trigger the deactivation unit upon reception of the deactivation trigger signal. The addition of a communication interface introduces the possibility of deactivating the provisional overvoltage protection device remotely. In a variant, the communication interface is realized by a button that upon its actuation forwards the deactivation trigger signal to the control unit. In a further variant, the communication interface comprises a connected lighting receiver. The connected lighting receiver is configured to receive the deactivation trigger signal and forward it to the control unit. In one variant, the deactivation trigger signal is a dedicated command solely for this purpose. In another variant the deactivation trigger signal is identical to a predetermined message that is additionally used in a commissioning process. In yet another variant, the control unit receives control packages via the connected lighting receiver and the first control package reaching the control unit is interpreted as the deactivation trigger signal.

It is noted that any of the above alternatives of accomplishing deactivation is provided alone in some embodiments, but in other embodiments provided in combination with another one of the above alternatives. For example, optical or electrical deactivation according to the third alternative may be provided in addition to the mechanical means described with respect to the first and second alternatives.

In a different embodiment of the luminaire of the first aspect, the luminaire additionally comprises a stress monitoring unit, which is configured to measure an amount of an electric current passing through the provisional overvoltage protection device and provide a stress monitoring signal indicative thereof. During overvoltage events, the amount of the electric current measured by the stress monitoring unit is indicative of, e.g., the type or severity of the disturbance. This information can, for example, be used to select a method of powering external construction machinery that causes the least amount of overvoltage events. Furthermore, the amount of electrical current passing through the provisional overvoltage protection device in the absence of overvoltage events also indicates the degradation that the provisional overvoltage protection device has suffered during previous overvoltage events.

In preferred embodiments of the luminaire of the first aspect, the runtime overvoltage protection device includes a metal oxide varistor element, hereinafter also referred to as MOV. The use of MOVs as a part of the runtime overvoltage protection device is advantageous due to their high resistance during normal voltage conditions and their low resistance during an overvoltage event, which shunts away a current caused by the overvoltage event from the remaining circuitry.

Suitably, in addition thereto or as an alternative, the provisional overvoltage protection device comprises or consists of a metal oxide varistor (MOV).

In another variant, in addition thereto or as an alternative, the provisional overvoltage protection device comprises a thyristor. The use of thyristors as part of the provisional overvoltage protection device is advantageous due to their high resistance during normal voltage conditions and their low resistance during an overvoltage event, which shunts away current caused by the overvoltage event from the remaining circuitry.

In one embodiment of the luminaire making use of a MOV in the provisional overvoltage protection device, and which includes the features of the third alternative for implementing deactivation using an electrical or optical deactivation pulse, as described above, and a stress monitoring unit. The provisional overvoltage protection device comprises a MOV which, in operation, only allows a leakage current flow of a leakage current amount that depends on an accumulated overvoltage stress caused by exposure to one or more previous overvoltage events. In this embodiment, the stress monitoring signal provided by the stress monitoring unit is indicative of the mentioned leakage current amount. The control unit receives the result signal and is configured to compare the leakage current amount indicated by the stress monitoring signal with a predetermined threshold. Furthermore, the control unit is configured to trigger the deactivation unit to provide the deactivation signal to the contact bridge in response to determining that the leakage current amount indicated by the stress monitoring signal exceeds the predetermined threshold.

This achieves an automatic deactivation of the provisional overvoltage protection device, which is advantageous since leakage currents can lead to overheating causing damage of the luminaire or even fire hazards.

In another preferred embodiment, the luminaire includes a circuit monitoring unit, which is configured to determine whether or not the provisional overvoltage protection device is deactivated, and to provide a circuit monitoring signal indicative thereof.

In one variant, the circuit monitoring unit is realized by a probe comprising a low voltage supply, a light source, and a pushbutton connected to a switch that are connected in parallel to the mechanically removable contact bridge. If the light source lights up when the button is pushed, the contact bridge is still in place.

In one embodiment, the luminaire comprises a housing with an opening, e.g., to allow access to a maintenance port, and two holes next to the opening. Furthermore, the luminaire comprises a cap (attached or as a separate part) for closing the opening that includes two pins. The two pins are arranged on the cap such that the two pins fit into the two holes when the cap is used to close the opening. Inside the housing underneath the two holes, a contact foil is located that is part of the parallel electrical connection between the provisional overvoltage protection device and the runtime overvoltage protection device. The pins punctuate the contact foil, when the cap is closed. As a result, the electrical connection between the provisional overvoltage protection device and the runtime overvoltage protection device is interrupted and the provisional overvoltage protection device is deactivated.

According to a second aspect of the invention, a luminaire kit is provided. The luminaire kit includes a luminaire unit, which comprises a first power connector of a first connector type and, in a first housing, a lighting module, a driver for driving the operation of the lighting module and a runtime overvoltage protection device for protecting the lighting module and the driver from exposure to overvoltage above a first overvoltage tripping limit. Furthermore, the luminaire kit includes a plug-in overvoltage protection unit, in a second housing, comprising a second power connector of a second connector type for establishing an electrical connection with the first power connector, a third power connector of the first connector type for establishing an electrical connection to an external power supply, and a provisional overvoltage protection device with a second overvoltage tripping limit that is smaller than the first overvoltage tripping limit and that is connected in parallel to the second and third power connectors.

The luminaire kit advantageously allows an easy addition or removal of the provisional overvoltage protection device to and from the luminaire. Through the configuration of the luminaire kit, it is possible to connect the luminaire through the plug-in overvoltage protection unit with the external power supply during exceptional operational circumstances. Due to the configuration of the tripping voltages of provisional and runtime overvoltage protection device and by connecting the plug-in overvoltage protection unit to an external power supply and the luminaire unit to the plug-in overvoltage protection unit, the provisional overvoltage protection device protects the runtime overvoltage protection device from overvoltage events and resulting degradation. During normal operational circumstances, the provisional overvoltage protection device removed by directly connecting the luminaire unit with the external power supply. Moreover, the plug-in overvoltage protection device can be re-used during subsequent exceptional operational circumstances.

In a variant of the second aspect of the invention, the luminaire kit additionally comprises a power cable for delivering DC supply power to the luminaire. The power cable comprises a fourth power connector of the second connector type, and a fifth power connector of the first connector type.

It shall be understood that the luminaire of claim 1 and the luminaire kit of claim 10, have similar and/or identical preferred embodiments, in particular, as defined in the dependent claims.

It shall be understood that a preferred embodiment of the present invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows a schematic circuit diagram of an embodiment of a luminaire;

FIG. 2 is a perspective view of a detail of a first variant of the luminaire of FIG. 1;

FIG. 3 is a perspective view of a detail of a second variant of the luminaire of FIG. 1;

FIG. 4 is a perspective view of a detail of a third variant of the luminaire of FIG. 1;

FIGS. 5 to 7 show schematic circuit diagrams of further embodiments of a luminaire;

FIG. 8 depicts a luminaire kit comprising a luminaire unit and a plug-in overvoltage protection unit; and

FIG. 9 depicts a variant of the luminaire kit of FIG. 8.

### DETAILED DESCRIPTION OF EMBODIMENTS

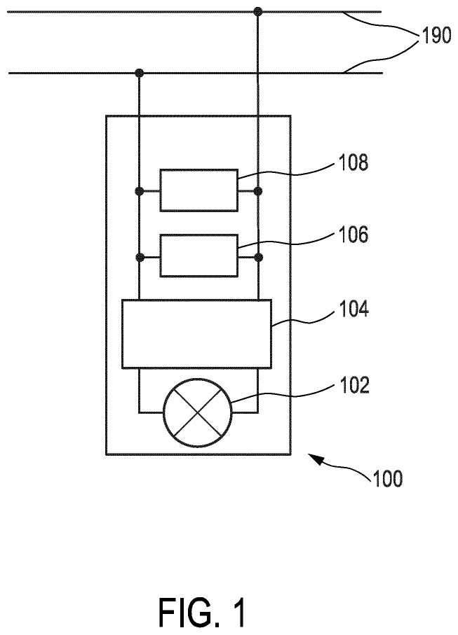

FIG. 1 shows a block diagram of a luminaire 100. The luminaire 100 comprises a lighting module 102 for emitting light, a driver 104 for driving the luminaire, a runtime overvoltage protection device 106 with a first overvoltage tripping limit, and a deactivatable provisional overvoltage protection device 108 with a second overvoltage tripping limit. The luminaire 100 is connected via two power lines 190 to an external power supply (not shown).

The runtime overvoltage protection device 106 is connected in parallel to the driver 104 and the lighting module 102, thereby protecting driver 104 and lighting module 102 against overvoltage events. The provisional overvoltage protection device 108 is connected in parallel to the runtime overvoltage protection device 106.

The runtime overvoltage protection device 106 includes a metal oxide varistor (MOV) element. MOVs exhibit a high resistance during normal voltage conditions and a low resistance during an overvoltage event under exposure to a voltage above the first overvoltage tripping limit. This achieves shunting away a current caused by the overvoltage event from the remaining circuitry.

The provisional overvoltage protection device 108 comprises or consists of a metal oxide varistor (MOV). In the present embodiment, the second overvoltage tripping limit (hereinafter also referred to in short as second tripping limit) of the provisional overvoltage protection device 108 is smaller than the first overvoltage tripping limit (first tripping limit) of the runtime overvoltage protection device 106. Thereby, the provisional overvoltage protection device 108 protects the runtime overvoltage protection device 106 against overvoltage events. In case of an overvoltage event exceeding the smaller second overvoltage tripping limit, electrical current caused by the overvoltage event is shunted away from both the runtime overvoltage protection device 106 and the remaining circuitry, in particular the driver 104. The provisional overvoltage protection device 108 is particularly useful under temporary exceptional operational circumstances where a high number of overvoltage events is expected. Under such exceptional operational circumstances, the provisional overvoltage protection device 108 protects the runtime overvoltage protection device 106 against a risk of degradation due to exposure to overvoltage events.

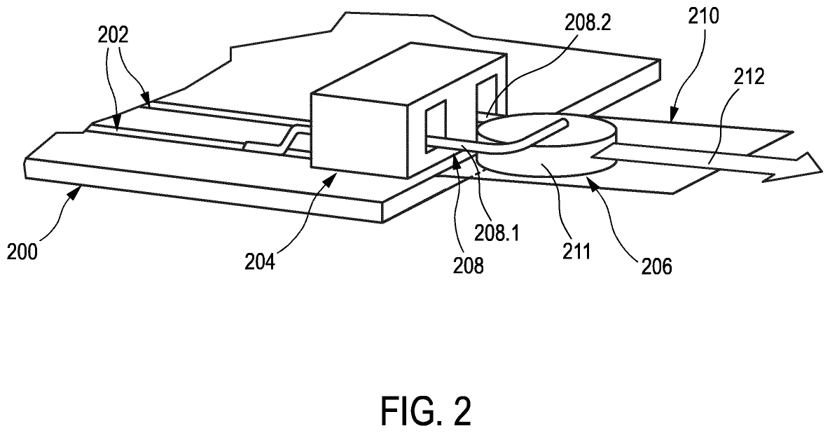

For operation of the luminaire 100 under normal operational circumstances, the provisional overvoltage protection device 108 can be deactivated. Different variants of the luminaire 100 of FIG. 1 provide different deactivation mechanisms. In the following, the different deactivation mechanisms will be described in more detail with reference to FIGS. 2 to 7.

FIG. 2 is a perspective view of a detail of a first variant of the luminaire of FIG. 1. In this variant, a provisional overvoltage protection device 206 can be deactivated by removing it from a socket 204. This will be explained in more detail in the following. The socket 204 is connected in parallel to the runtime overvoltage protection device 106 of FIG. 1 (not shown in FIG. 2) via a conductor trace 202. Both, the conductor trace 202 and the socket 204 are mounted on a printed circuit board 200 that serves as a support. A contact bridge 208 has two pins 208.1 and 208.2 and a removable provisional overvoltage protection device 206. The contact bridge 208 is shown in FIG. 2 in a state, in which the removable provisional overvoltage protection device 206 is inserted and connected between the pins 208.1 and 208.2 of the contact bridge 208. The removable provisional overvoltage protection device 206 has a carrier 210, for example a foil, attached to a MOV element 211 that in an inserted state is connected between the pins 208.1 and 208.2 of the contact bridge 208. The carrier 210 has an arrow 212 and serves as a grip to remove the contact bridge 208 including the provisional overvoltage protection device 206 from the socket 204. The red arrow 212 serves as an obtrusive signal indicating that the provisional overvoltage protection device 206 is currently in place and specifying the pulling direction for its removal.

In another variant, which is not shown here, the positions of the pins and the socket are switched such that the conductor trace comprises the two pins and the provisional overvoltage protection device is connected to a socket that is removably plugged into the pins.

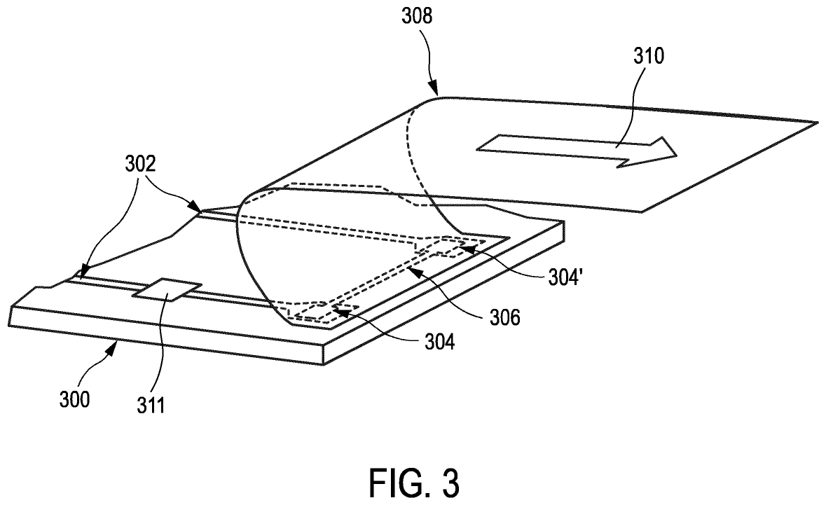

FIG. 3 is a perspective view of a detail of a second variant of the luminaire of FIG. 1. In particular, FIG. 3 shows a detail of a variant of the luminaire 100 of FIG. 1 wherein a removable contact bridge 306 is used for deactivating a provisional overvoltage protection device 311. This will be explained in more detail in the following.

The contact bridge 306 connects two solder joints 304 and 304′ that are part of a conductor trace 302 which connects the provisional overvoltage protection device 311 in parallel to the runtime overvoltage protection device 106 of FIG. 1. The solder joints 304 and 304′ and the conductor trace 302 are mounted on a printed circuit board 300 that serves as a support. The contact bridge 306 is arranged on a foil 308 which is removably attached to the printed circuit board 300. The foil 308 comprises an arrow 310.

By pulling on the foil, the contact bridge is removed and the connection trace 302 is thus opened, thereby deactivating the provisional overvoltage protection device 311. The arrow 310 indicates the direction of the removal of the contact bridge 306.

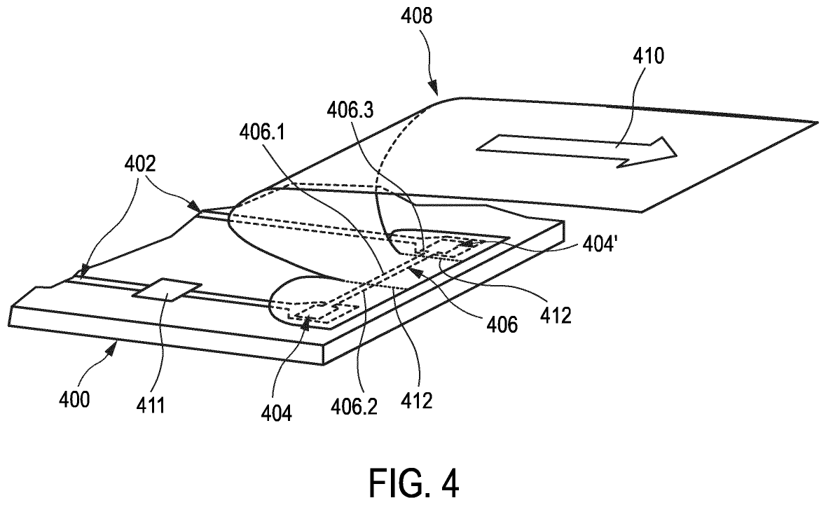

FIG. 4 is a perspective view of a detail of a third variant of the luminaire of FIG. 1. In particular, FIG. 4 depicts a variant of the foil 310 of FIG. 3 that includes predetermined break points.

In the depicted variant, the printed circuit board 400, the conductor trace 402, the solder joints 404 and 404′, the contact bridge 406, the foil 408 and the provisional overvoltage protection device 411 are substantially identical to the corresponding elements shown in FIG. 3, and therefore have corresponding reference labels differing only in the first digit. The following concentrates on the differences between the variants of FIGS. 3 and 4. In the variant depicted in FIG. 4, the foil 408 includes two lines 412 of mechanical break points. When applying a pulling force to the foil, it will break as defined by the break points 412 and only a removable part 406.1 of the contact bridge 406 will be removed, while remaining parts 406.2 and 406.3 of the contact bridge 406 and corresponding parts of the foil 408 will remain on the printed circuit board 400. Despite the remaining parts 406.2 and 406.3 of the contact bridge, by pulling of the removable part 406.1 of the contact bridge 406, the provisional overvoltage protection device 411 of FIG. 4 is deactivated. Similar as in FIG. 3, the foil 408 comprises an arrow 410 that indicates the direction of removal of the foil. However, it should be noted that the provision of the arrow 410 is not a necessary technical requirement and serves as a visual indication for guiding installation staff.

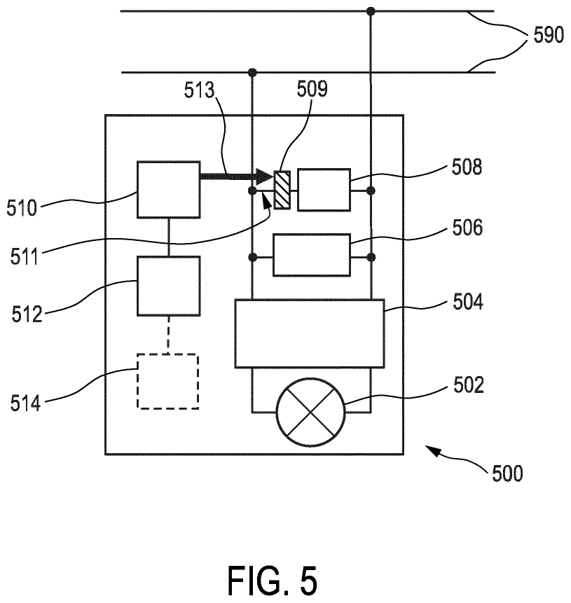

While FIGS. 2 to 4 depict variants of a mechanical deactivation mechanism, a different type of deactivation mechanism is illustrated in FIG. 5 and will be described in the following.

FIGS. 5 to 7 show schematic circuit diagrams of further embodiments of a luminaire. The luminaire FIG. 5 shows a block diagram of a luminaire 500 that includes a provisional overvoltage protection device 508 and a conductive electrical contact bridge 509 that, by receiving an optical or electrical deactivation pulse, is removable or transformable to a non-conductive trace section.

Identical to the luminaire 100 of FIG. 1, the luminaire 500 of FIG. 5 comprises a lighting module 502, a driver 504, a runtime overvoltage protection device 506, and a provisional overvoltage protection device 508. Furthermore, the luminaire 500 is connected via two power lines 590 to an external power supply (not shown).

The luminaire 500 differs from the luminaire 100 depicted in FIG. 1 in that a conductor trace 511 that is in parallel connection to the runtime overvoltage protection device 506 comprises a conductive electrical contact bridge 509 in series with the overvoltage protection device 508. The electrical contact bridge 509 is deactivatable, as will be described below. Furthermore, the luminaire 500 comprises a deactivation unit 510 and a control unit 512.

Deactivation of the electrical contact bridge will be described in the following. To this end, the control unit 512 is configured to trigger the deactivation unit 510 to provide a deactivation pulse to the contact bridge 509, which is indicated by an arrow 513 in FIG. 5. In different variants of the luminaire 500, the deactivation pulse is either an optical pulse or an electrical pulse. The pulse exhibits a power amount suitable to remove or transform the contact bridge 509, rendering the contact bridge non-conductive and thus disrupting the electrical connection between the runtime overvoltage protection device 506 and the provisional overvoltage protection device 508 and thus deactivating the provisional overvoltage protection device. In one variant of this embodiment, the conductive electrical contact bridge 509 is a onetime fusible trace. In this case, the deactivation pulse is an electrical current generated by the deactivation unit. The current has an amount suitable for burning the onetime fusible trace when the deactivation unit 510 is trigged by the control unit 512. In another variant, the deactivation unit 512 is a light source emitting a light pulse of suitable energy and power, and the conductive electrical contact bridge 509 is made of a conductive photosensitive material that degrades to a non-conductive material when hit by the light pulse emitted from the deactivation unit 510. In yet another variant, the light emitted by the lighting module 502 is used for transforming or removing the conductive electrical contact bridge 509. More specifically, the electrical contact bridge 509 is made of a photosensitive material that degrades in response to exposure to a light pulse emitted by the lighting module 502. In this variant, the deactivation unit 510 is arranged along a device-internal propagation path of leak light or scattered light emitted by the lighting module 500 and directed towards the electrical contact bridge 509, inside a housing of the luminaire 500. The deactivation unit 510 suitably comprises a shutter (not shown) that, when the shutter is closed, shields the conductive electrical contact bridge 509 from the leak light or scattered light. The deactivation unit 510 opens the shutter when triggered by the control unit 512 and, as a result, the material of the conductive electrical contact bridge 509 is exposed to the leak light or scattered light and degraded to form the non-conductive material. As a result, the provisional overvoltage protection device 508 is deactivated.

Some variants of the luminaire 500 also include a communication interface 514 connected to the control unit 512. Since the communication interface 514 is an optional component, it is represented by a box having a dashed outline. The communication interface 514 is configured to receive a deactivation trigger signal and to forward it to the control unit 512. The control unit 512 is configured to trigger the deactivation unit 510 upon reception of the deactivation trigger signal. In different variants, the communication interface 514 is configured to receive a manual, electrical or electromagnetic deactivation trigger signal.

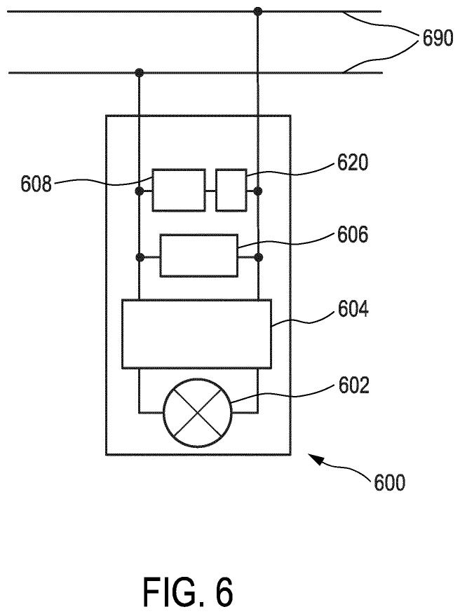

FIG. 6 is a schematic circuit diagram of a further embodiment of a luminaire that includes a stress monitoring unit for monitoring exposure of the luminaire to overvoltage events.

The luminaire 600 depicted in FIG. 6 comprises a lighting module 602, a driver 604, a runtime overvoltage protection device 606, and a provisional overvoltage protection device 608. For details, reference is made to the description of the embodiment of FIG. 1, which also comprises these units. Additionally, a stress monitoring unit 620 is connected in series with the provisional overvoltage protection device 608. The stress monitoring unit 620 is configured to measure an amount of electric current passing through the provisional overvoltage protection device 608 and to provide a stress monitoring signal indicative thereof. During overvoltage events, the amount of the electric current measured by the stress monitoring unit is indicative of, e.g., the type or severity of the disturbance. This information can, for example, be used to select a method of powering external construction machinery that causes the least amount of overvoltage events. Furthermore, the amount of electrical current passing through the provisional overvoltage protection device in the absence of overvoltage events also indicates the degradation that the provisional overvoltage protection device has suffered during previous overvoltage events.

More specifically, as mentioned, luminaires are typically protected against overvoltage events by using overvoltage protection devices that include a MOV. The MOV serves to shunt the current created by overvoltage spikes away from sensitive components when the overvoltage spikes exceed a predetermined threshold amplitude, herein referred to as overvoltage tripping limit. While MOVs are effective in protecting luminaires against overvoltage conditions, they suffer from degradation when exposed to a few large transients, to many small transients or to overvoltage extending over a larger time span. As a MOV degrades, its overvoltage tripping limit is lowered, which results in increased leakage current. Therefore, the amount of current measured by the stress monitoring unit 620 in the absence of overvoltage events is a measure for the degradation of the MOV and may be used to implement an automatic deactivation mechanism for the provisional overvoltage protection device.

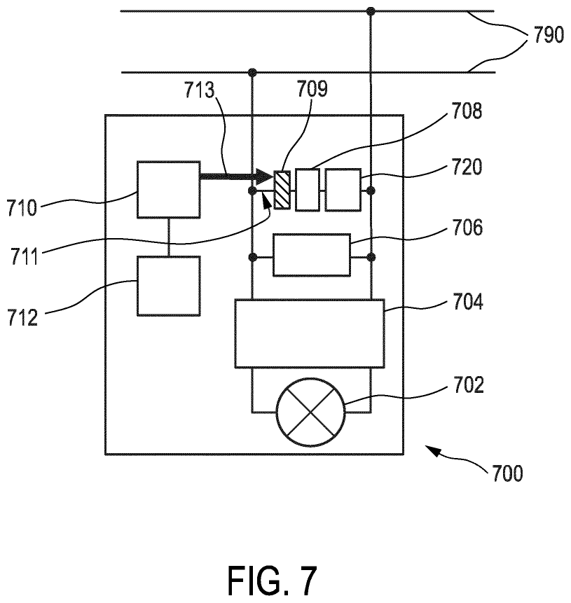

In the following, an embodiment of a luminaire will be described with reference to FIG. 7, in which the monitoring described in the context of the embodiment of FIG. 6 is used to allow automatically triggering the deactivation of the overvoltage protection device. FIG. 7 is a schematic circuit diagram of a further embodiment of a luminaire 700 comprising an automatic deactivation mechanism of a provisional overvoltage protection device.

Similar to the luminaire 500 shown in FIG. 5, the luminaire 700 is connected to a power supply (not shown) via two power lines 790 and comprises a lighting module 702, a driver 704, a runtime overvoltage protection device 706, a provisional overvoltage protection device 708, a deactivatable contact bridge 709, a deactivation unit 710, and a control unit 712. Also, a conductor trace 711 is arranged in parallel connection to the runtime overvoltage protection device 706 and comprises a conductive electrical contact bridge 709 in series with the overvoltage protection device 708. In addition, the luminaire 700 comprises a stress monitoring unit 720 arranged in series connection with the provisional overvoltage protection device 708 and the contact bridge 709, and in parallel connection to the runtime overvoltage protection device 706.

The stress monitoring unit 720 measures an amount of leakage current allowed by the overvoltage protection device 708 and forwards a result signal indicative thereof to the control unit 712. If the amount of leakage current surpasses a predetermined threshold, the control unit 712 triggers the deactivation unit 710, which then provides a deactivation signal (indicated by an arrow 713 in FIG. 7) to the contact bridge 709. Thereby, the provisional overvoltage protection device 708 is deactivated.

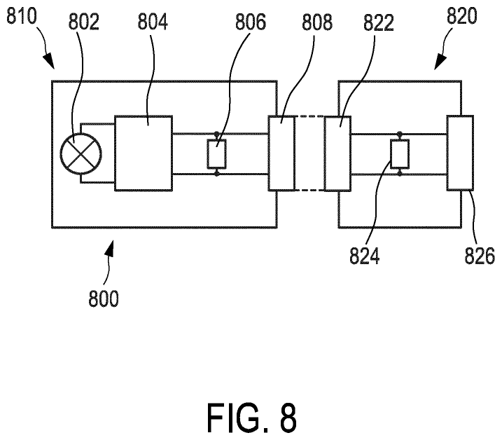

FIG. 8 depicts a luminaire kit 800 comprising a luminaire unit 810 and a plug-in overvoltage protection unit 820.

The luminaire unit 800 comprises a lighting module 802 for emitting light, a driver 804 driving the lighting module 802, a runtime overvoltage protection device 806 with a first tripping limit, and a power connector 808 of a first connector type in a first housing. The runtime overvoltage protection device 806 is connected in parallel to the driver 804 and the lighting module 802, thereby protecting them against overvoltage events.

The plug-in overvoltage protection unit 820 comprises a provisional overvoltage protection device 824 with a second tripping limit, a power connector 822 of a second type, and a power connector 826 of the first type in a second housing. The provisional overvoltage protection device 824 is connected in parallel to the power connectors 822 and 826. Furthermore, the second overvoltage tripping limit is smaller than the first overvoltage tripping limit.

Generally, here and in the following description of further embodiments, a power connector of the first type, such as the power connector 808, and a power connector of the second type, such as the power connector 822, are suitable for establishing a mutual mechanical connection with each other to also provide a mutual electrical connection.

During normal operational circumstances, the power connector 808 of the luminaire unit 800 is directly connected to a power connector of an external power supply (not shown), which has a power connector of the second type. In this case, the runtime overvoltage device 806 protects the driver 804 and the luminaire 802 against overvoltage events under normal operation.

For additional protection in times of temporary exceptional operational conditions, the plug-in overvoltage protection unit 820 is to be inserted between the luminaire unit 800 and the external power supply. In this case, the provisional overvoltage protection device 824 is thus connected in parallel to the runtime overvoltage protection device 806. Due to the lower overvoltage tripping limit of the provisional overvoltage protection device 824, the plug-in overvoltage protection unit 820 protects the luminaire unit 800 including the runtime overvoltage protection device 806 against overvoltage events.

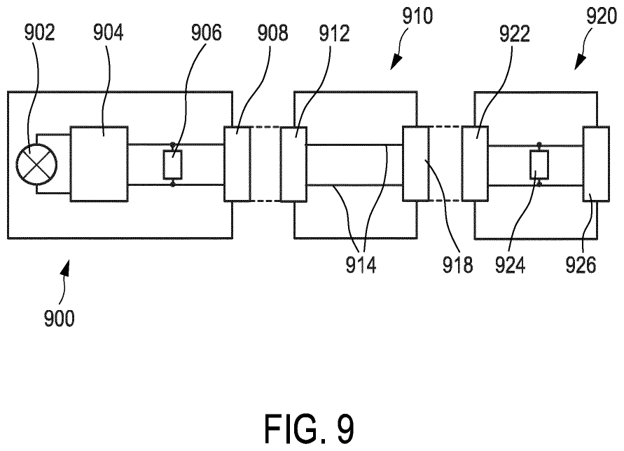

In a variant, the luminaire kit is complemented by a cable, which will be discussed in the following with reference to FIG. 9. FIG. 9 depicts a further embodiment of a luminaire kit comprising a luminaire unit 900, a plug-in overvoltage protection device 920, and a cable 910.

The cable 910 comprises a power connector 912 of the second type and a power connector 914 of the first type that are electrically connected via conductors 914. The luminaire unit 900 and the plug-in overvoltage protection device 920 are identical to the luminaire unit 800 and the plug-in overvoltage protection device 820 depicted in FIG. 8.

Due to a suitable selection of the types of the power connectors, the cable 910 can be used to connect the luminaire 900 with an external power source (not shown) in case of normal operational circumstances. In case of exceptional operational circumstances, the cable 900 can be inserted between luminaire unit 900 and the plug-in overvoltage protection device 920, or between the plug-in overvoltage protection device 920 and an external power supply.

In summary, the invention is related to a luminaire comprising a lighting module for emitting light, a driver for driving operation of the lighting module, a runtime overvoltage protection device for protecting the lighting module and the driver from exposure to overvoltage above a first overvoltage tripping limit, and a provisional overvoltage protection device that is connected in parallel to the runtime overvoltage protection device and has a second overvoltage tripping limit. The second tripping limit smaller than the first overvoltage tripping limit so that the provisional overvoltage protection device provides overvoltage protection to the runtime overvoltage protection device. Moreover, the provisional overvoltage protection device is deactivatable.

In the claims, the word “comprising” does not exclude other elements or steps, and the indefinite article “a” or “an” does not exclude a plurality.

A single step or other units may fulfill the functions of several items recited in the claims. The mere fact that certain measures are recited in mutually different dependent claims does not indicate that a combination of these measures cannot be used to advantage.

Any reference signs in the claims should not be construed as limiting the scope.

1. A luminaire comprising
a lighting module for emitting light,
a driver for driving operation of the lighting module,
a runtime overvoltage protection device for protecting the lighting module and the driver from exposure to overvoltage above a first overvoltage tripping limit,
a provisional overvoltage protection device that is connected in parallel to the runtime overvoltage protection device and has a second overvoltage tripping limit smaller than the first overvoltage tripping limit so as to provide overvoltage protection to the runtime overvoltage protection device, wherein the provisional overvoltage protection device is deactivatable thereby causing the luminaire to operate under overvoltage protection of only the runtime overvoltage protection device after the deactivation,
a support arranged for carrying, a conductor trace for establishing a parallel electrical connection between the runtime overvoltage protection and the provisional overvoltage protection device, and either:
(i) the luminaire further comprises a socket that is connected to the conductor trace, in parallel to the runtime overvoltage protection device, and an electrical contact, bridge that is removably plugged into the socket and comprises the provisional overvoltage protection device, and arranged such that removing the electrical contact bridge causes the electrical connection between the runtime overvoltage protection device and the provisional overvoltage protection device to open and thus deactivate the provisional overvoltage protection device; or,
(ii) the conductor trace comprises, in series with the provisional overvoltage protection device, solder joints electrically connected by an electrical contact bridge that is arranged on a foil which is removably attached to the support, arranged such that by removing the foil the electrical contact bridge (306) is removed as well, and the electrical connection between the runtime overvoltage protection device and the provisional overvoltage protection device becomes disrupted, thereby deactivating the provisional overvoltage protection device; or
(iii) the conductor trace comprises a conductive electrical contact bridge arranged such that, by receiving an optical or electrical deactivation pulse, is removable or transformable to a non conductive trace section, thus disrupting the electrical connection between the runtime overvoltage protection device and the provisional overvoltage protection device and thus deactivating the provisional overvoltage protection device, and the luminaire comprises a deactivation unit that is configured to generate and provide the electrical or optical deactivation pulse; and a control unit that is connected to the deactivation unit and is configured to trigger the deactivation unit to generate and provide the deactivation pulse to the contact bridge.

2. (canceled)

3. (canceled)

4. (canceled)

5. The luminaire of claim 1 comprises a conductive electrical contact bridge arrayed such that, by receiving an optical or electrical deactivation pulse, is removable or transformable to a non-conductive trace section, thus disrupting the electrical connection between the runtime overvoltage protection device and the provisional overvoltage protection device and thus deactivating the provisional overvoltage protection device, and the luminaire comprises a deactivation unit that is configured to generate and provide the electrical or optical deactivation pulse and a control unit that is connected to the deactivation unit and configured to trigger the deactivation unit to generate and provide the deactivation pulse to the contact bridge, and wherein the luminaire further comprises:
a communication interface that is configured to receive a deactivation trigger signal from an external signal source and that is configured to forward the deactivation trigger signal to the control unit; and
the control unit is configured to trigger the deactivation unit upon reception of the deactivation trigger signal.

6. The luminaire of claim 1, including a stress monitoring unit, which is configured to measure an amount of electric current passing through the provisional overvoltage protection device and provide a stress monitoring signal indicative thereof.

7. The luminaire of claim 6, wherein
the provisional overvoltage protection device includes a metal oxide varistor element, hereinafter MOV element, allowing, in operation of the luminaire, only a leakage current flow of a leakage current amount depending on an accumulated overvoltage stress caused by exposure to one or more previous overvoltage events; and wherein
the stress monitoring signal provided by the stress monitoring unit is indicative of the leakage current amount,
the control unit is arranged to receive the result signal and configured to compare the leakage current amount indicated by the stress monitoring signal with a predetermined threshold, and to trigger the deactivation unit to provide the deactivation signal to the contact bridge in response to determining that the leakage current amount indicated by the stress monitoring signal exceeds the predetermined threshold.

8. The luminaire of claim 1, wherein the provisional overvoltage protection device includes a thyristor.

9. The luminaire of claim 1, wherein the luminaire includes a circuit monitoring unit, which is configured to determine whether or not the provisional overvoltage protection device is deactivated and to provide a circuit monitoring signal indicative thereof.

10. The luminaire of claim 1, wherein the runtime overvoltage protection device includes a metal oxide varistor element, hereinafter MOV element.

11. (canceled)
